(19) United States
(12) Patent Application Publication
(10) Pub. No.: US 2019/0179915 A1
(43) Pub. Date: Jun. 13, 2019

(54) METHOD AND APPARATUS FOR RECOMMENDING ITEM USING METADATA

(71) Applicant: ELECTRONICS AND TELECOMMUNICATIONS RESEARCH INSTITUTE, Daejeon (KR)

(72) Inventors: Yeo Chan YOON, Seoul (KR); Baek Seob Kim, Seoul (KR); Ah Young Kim, Seoul (KR); Soo Myung Park, Daejeon (KR); Jun Woo Lee, Daejeon (KR)

(21) Appl. No.: 15/849,939

(22) Filed: Dec. 21, 2017

(30) Foreign Application Priority Data
Dec. 13, 2017 (KR) 10-2017-0171325

(51) Int. Cl. G06F 17/30; G06N 5/00

(52) U.S. Cl. CPC G06F 17/3053; G06N 5/003; G06F 17/30309

(57) ABSTRACT

A method for recommending an item includes generating a metadata latent vector and an item latent vector based on an item database and a usage history database of items for a specific user; predicting a user latent vector from user information obtained from the specific user based on the usage history database and one of the metadata latent vector and the item latent vector; and generating a recommendation list by extracting at least one recommendation item from the item database based on the user latent vector and the item latent vector.

### CROSS-REFERENCE TO RELATED APPLICATIONS

This application claims priority to Korean Patent Application No. 10-2017-0171325, filed Dec. 13, 2017 in the Korean Intellectual Property Office (KIPO), the entire content of which is hereby incorporated by reference.

### BACKGROUND

### 1. Technical Field

The present disclosure relates to a method and an apparatus for recommending an item by using metadata, and more specifically, to a method and an apparatus for recommending contents or items having similar metadata.

### 2. Description of Related Art

Development of Internet provided a distribution platform for easily purchasing multimedia contents such as music, movies, games, or offline products through online. However, the number of products distributed on-line is enormous, making it difficult for users to find desired products. In addition, it was also required for distributors to appropriately recommend products preferred by users in order to increase sales.

Accordingly, global companies such as Google, Amazon, and Microsoft have been developing and applying recommendation systems that automatically analyze users' preferences for product and content distribution for years, and continue to develop the recommendation systems. Such the recommendation system effectively recommends appropriate items or contents to an individual user, but there is a need to recommend similar items or contents when there are no appropriate items or contents exactly matched to the user's preferences.

### SUMMARY

Accordingly, embodiments of the present disclosure provide a method for recommending an item by using metadata.

Also, embodiments of the present disclosure provide an apparatus for recommending an item by using metadata.

In order to achieve the objective of the present disclosure, a method for recommending an item may comprise generating a metadata latent vector and an item latent vector based on an item database and a usage history database of items for a specific user, predicting a user latent vector from user information obtained from the specific user based on the usage history database and one of the metadata latent vector and the item latent vector, and generating a recommendation list by extracting at least one recommendation item from the item database based on the user latent vector and the item latent vector.

The generating of the metadata latent vector and the item latent vector may further comprise generating the metadata latent vector based on the item database and the item usage history database; and generating the item latent vector based on the usage history database and at least one intermediate vector learned when the metadata latent vector is generated.

The generating of the metadata latent vector may further comprise generating a first training set based on the usage history database; generating a second training set based on the item database; and generating the metadata latent vector by learning the first training set and the second training set through machine learning.

The learning of the first training set and the second training may comprise learning the first training set and the second training set by using a Word2Vec algorithm.

The generating of the item latent vector may further comprise generating a training set based on the usage history database; obtaining the at least one intermediate vector, and generating the item latent vector by learning the training set and the at least one intermediate vector through machine learning.

The learning of the training set and the at least one intermediate vector may comprise learning the training set and the at least one intermediate vector by using a back-propagation algorithm.

The predicting may comprise obtaining weights for the specific user based on the usage history database.

The predicting may further comprise predicting a first user latent vector from the user information based on the item latent vector and the weights; and predicting a second user latent vector from the user information based on the metadata latent vector and the weights.

The generating of the recommendation list may comprise generating the recommendation list by extracting the at least one recommendation item from the item database based on the item latent vector and one of the first user latent vector and the second user latent vector.

The generating of the recommendation list may further comprise generating the recommendation list by extracting the at least one recommendation item from the item database based on an inner product of the user latent vector and the item latent vector.

In order to achieve the objective of the present disclosure, an apparatus for recommending an item may comprise a processor and a memory storing at least one instruction executed by the processor. Also, the at least one instruction may be configured to generate a metadata latent vector and an item latent vector based on an item database and a usage history database of items for a specific user, predict a user latent vector from user information obtained from the specific user based on the usage history database and one of the metadata latent vector and the item latent vector and generate a recommendation list by extracting at least one recommendation item from the item database based on the user latent vector and the item latent vector.

The at least one instruction may be further configured to generate the metadata latent vector based on the item database and the item usage history database; and generate the item latent vector based on the usage history database and at least one intermediate vector learned when the metadata latent vector is generated.

The at least one instruction may be further configured to generate a first training set based on the usage history database; generate a second training set based on the item database; and generate the metadata latent vector by learning the first training set and the second training set through machine learning.

The at least one instruction may be further configured to learn the first training set and the second training set by using a Word2Vec algorithm.

The at least one instruction may be further configured to generate a training set based on the usage history database; obtain the at least one intermediate vector, and generate the item latent vector by learning the training set and the at least one intermediate vector through machine learning.

The at least one instruction may be further configured to learn the training set and the at least one intermediate vector by using a back-propagation algorithm.

The at least one instruction may be further configured to obtain weights for the specific user based on the usage history database.

The at least one instruction may be further configured to predict a first user latent vector from the user information based on the item latent vector and the weights; and predict a second user latent vector from the user information based on the metadata latent vector and the weights.

The at least one instruction may be further configured to generate the recommendation list by extracting the at least one recommendation item from the item database based on the item latent vector and one of the first user latent vector and the second user latent vector.

The at least one instruction may be further configured to generate the recommendation list by extracting the at least one recommendation item from the item database based on an inner product of the user latent vector and the item latent vector.

According to embodiments of the present disclosure, items or contents whose metadata values are different from those of items or contents desired by a user but similar to those may be recommended. Also, it may be made possible to improve the recommendation performance by using a metadata vector as a feature when learning item vectors. Also, it may be made possible to recommend items using only metadata, so that items without usage history can be effectively recommended.

### BRIEF DESCRIPTION OF DRAWINGS

Embodiments of the present disclosure will become more apparent by describing in detail embodiments of the present disclosure with reference to the accompanying drawings, in which:

FIG. 1 is a block diagram illustrating an item recommendation apparatus according to an embodiment of the present disclosure;

FIG. 2 is a block diagram illustrating a metadata latent vector learning part according to an embodiment of the present disclosure;

FIG. 3 is a block diagram illustrating an item latent vector learning part according to an embodiment of the present disclosure;

FIG. 4 is a conceptual diagram for explaining a method of learning an item latent vector using an intermediate vector according to an embodiment of the present disclosure;

FIG. 5 is a block diagram illustrating a user latent vector predicting part according to an embodiment of the present disclosure;

FIG. 6 is a flowchart for explaining a method for recommending items according to an embodiment of the present disclosure; and

FIG. 7 is a flowchart for explaining a method of recommending metadata based on an item recommendation apparatus according to an embodiment of the present disclosure.

### DETAILED DESCRIPTION

Embodiments of the present disclosure are disclosed herein. However, specific structural and functional details disclosed herein are merely representative for purposes of describing embodiments of the present disclosure, however, embodiments of the present disclosure may be embodied in many alternate forms and should not be construed as limited to embodiments of the present disclosure set forth herein.

Accordingly, while the present disclosure is susceptible to various modifications and alternative forms, specific embodiments thereof are shown by way of example in the drawings and will herein be described in detail. It should be understood, however, that there is no intent to limit the present disclosure to the particular forms disclosed, but on the contrary, the present disclosure is to cover all modifications, equivalents, and alternatives falling within the spirit and scope of the present disclosure. Like numbers refer to like elements throughout the description of the figures.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present disclosure. As used herein, the term “and/or” includes any and all combinations of one or more of the associated listed items.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (i.e., “between” versus “directly between,” “adjacent” versus “directly adjacent,” etc.).

The terminology used herein is for the purpose of describing particular embodiments only and is not intended to be limiting of the present disclosure. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this present disclosure belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, embodiments of the present disclosure will be described in greater detail with reference to the accompanying drawings.

The present disclosure proposes a method of recommending an item having more similar metadata values in preference to other items by comparing similarities between metadata values even when the metadata values do not match exactly. For example, when an item is recommended based on a color of a specific product, among a black-colored product and an orange-colored product, the orange-colored product may be recommended for a user who prefers red color. Also, when a user prefers a specific movie director, a movie director having tendencies similar to those of the preferred specific move director may be recommended. An item recommendation apparatus according to an embodiment of the present disclosure may also recommend contents such as movies as well as items such as products, but the contents may also be referred to as ‘item’ in the below description for convenience of explanation.

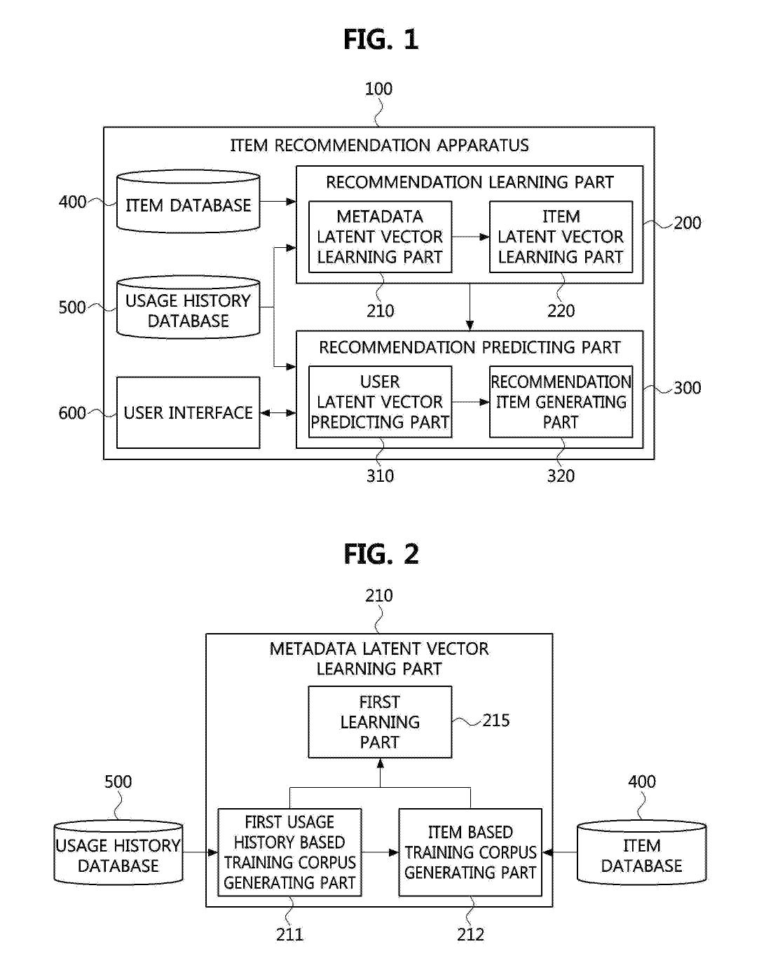

FIG. 1 is a block diagram illustrating an item recommendation apparatus according to an embodiment of the present disclosure.

Referring to FIG. 1, an item recommendation apparatus 100 according to an embodiment of the present disclosure may comprise a recommendation learning part 200, a recommendation predicting part 300, an item database 400, and a usage history database 500, and may further comprise a user interface 600. Here, the components of the item recommendation apparatus 100 are not limited to their names, but the components may be defined by the corresponding functions. Also, a plurality of the functions may be performed by one component, and a plurality of the components may perform one function.

The recommendation learning part 200 may generate a metadata latent vector and an item latent vector based on the item database 400 and the usage history database 500 through machine learning. Here, the recommendation learning part 200 may include a metadata latent vector learning part 210 and an item latent vector learning part 220.

The metadata latent vector learning part 210 may generate the metadata latent vector based on the item database 400 and the usage history database 500. In other words, a training set may be generated from each of the item database 400 and the usage history database 500, and the generated training set may be learned to generate the metadata latent vector. A more detailed description of the metadata latent vector learning part 210 will be described later with reference to FIG. 2.

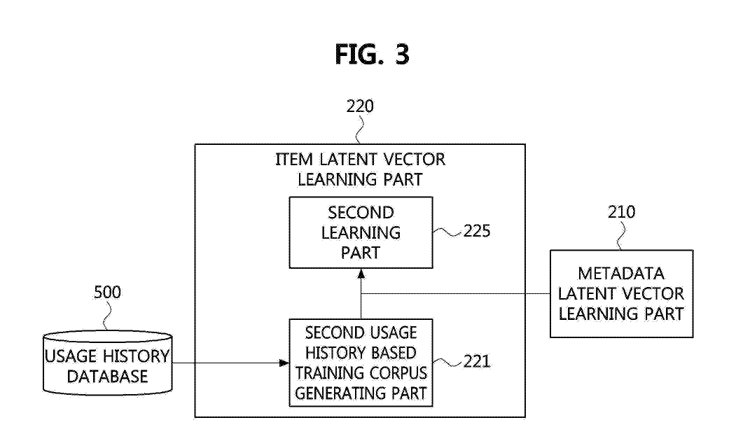

The item latent vector learning part 220 may generate the item latent vector based on the usage history database 500 and intermediate vectors learned when generating the metadata latent vector. In other words, the training set may be generated from the usage history database 500, the intermediate vectors may be obtained when the metadata latent vector is generated from the metadata latent vector learning part 210, and the item latent vector may be generated by learning the generated training set and the obtained intermediate vectors. A more detailed description of the item latent vector learning part 220 will be described later in detail with reference to FIG. 3.

The recommendation predicting part 300 may predict a user latent vector from information on a specific user obtained from the user interface 600 based on the usage history database 500 and one of the metadata latent vector and the item latent vector generated in the above-described recommendation learning part 200, and generate a recommendation list by extracting at least one recommendation item from the item database 400 based on the predicted user latent vector and the item latent vector. Here, the recommendation predicting part 300 may include a user latent vector predicting part 310 and a recommendation item generating part 320.

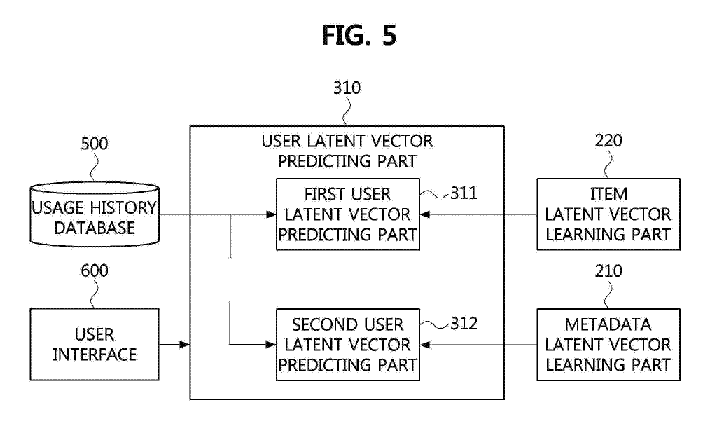

The user latent vector predicting part 310 may predict a first user latent vector from information on the specific user obtained from the user interface 600 based on the item latent vector generated by the recommendation learning part 200 and the usage history database 500, and predict a second user latent vector from the information on the specific user based on the metadata latent vector generated by the recommendation learning part 200 and the usage history database 500. Also, the user latent vector predicting part 310 may obtain weights for the user based on the usage history database 500, and may predict the first user latent vector or the second user latent vector using the obtained weights. A more detailed description of the user latent vector predicting part 310 will be described later with reference to FIG. 5.

The recommendation item generating part 320 may generate the recommendation list by extracting at least one recommendation item from the item database based on the user latent vector predicted by the user latent vector predicting part 310 and the item latent vector generated by the recommendation learning part 200. Here, the user latent vector may include one of the first user latent vector using the item latent vector and the second user latent vector using the metadata latent vector.

The recommendation item generating part 320 may calculate scores of the at least one recommendation item using an inner product of the user latent vector and the item latent vector, and may generate the recommendation list based on the calculated scores. A more detailed description of the recommendation item generating part 320 will be described with reference to FIG. 5.

The item database 400 may include metadata of items and additional information such as documents in which the items appear. The usage history database 500 may include usage history information on items purchased or used by a user, and the usage history information on the items may be managed and stored separately for each user.

The user interface 600 may receive user information from a specific user and provide the user information to the item recommendation apparatus 100. Also, the user interface 600 may provide the recommendation list generated by the item recommendation apparatus 100 to the specific user. The user interface 600 may provide predetermined questions, such as a survey, to the specific user, and may obtain the user information of the specific user based on answers to the questions entered by the specific user. However, the obtaining the user information may be performed in various manners. Also, the user interface 600 may directly store the received user information in the usage history database 500, and after the usage history database 500 is constructed, all of the user information may be obtained from the usage history database 500. Here, the user interface 600 may be connected to a specific display device, and may receive the user information and display the recommendation list through the specific display device.

The item recommendation apparatus 100 may include at least one processor and a memory storing at least one instruction through which the above-described operations are performed by the at least one processor. Here, the at least one processor may execute program commands stored in the memory and may be a central processing unit (CPU), a graphics processing unit (GPU), or a dedicated processor. The memory may be constituted by a volatile storage medium and/or a non-volatile storage medium, and may be composed of a read only memory (ROM) and/or a random access memory (RAM).

FIG. 2 is a block diagram illustrating a metadata latent vector learning part according to an embodiment of the present disclosure.

Referring to FIG. 2, the metadata latent vector learning part 210 according to an embodiment of the present disclosure may comprise a first usage history based training corpus generating part 211, an item based training corpus generating part 212, and a first learning part 215. Here, the components of the metadata latent vector learning part 210 may be not limited to their names, but may be defined by their corresponding functions to be described later. Also, a plurality of the functions may be performed by one component, and a plurality of the components may perform one function.

The first usage history based training corpus generating part 211 may generate the first training set based on the item usage history of the user stored in the usage history database 500. Here, the first training set may be generated by pairing metadata values included in the items used by the user. For example, if two items used by the user both include metadata values i and j, and the user evaluates both items positively, then a piece of training data, which is to be included in the first training set, may be generated by grouping i and j into a pair.

The item based training corpus generating part 212 may generate the second training set based on the metadata of the items stored in the item database 400. Here, the second training set may be generated by grouping two metadata values appearing in the same item. For example, if a piece of data includes metadata values i and j, or if the metadata values i and j appear simultaneously in one item, i and j may be grouped into a pair so that a piece of training data, which is to be included in the second training set, may be generated. As a specific example, when move directors A and B appear in the same news data, A and B may be grouped into a pair and may be generated as a piece of training data included in the second training set. If tag information of a specific movie include ‘#calm’ and ‘#lyrical’, a metadata value indicating ‘#calm’ and a metadata value indicating ‘#lyrical’ may be grouped into a pair, and the pair may be generated as a piece of training data to be included in the second training set.

The first learning part 215 may perform learning based on the first training set and the second training set to generate the metadata latent vector. Here, the first learning part 215 may use the Word2Vec algorithm, but the embodiment is not limited thereto, and various machine learning or artificial neural network algorithms such as a support vector machine (SVM) may be used. The detailed operation of the metadata latent vector learning part 210 according to an embodiment of the present disclosure will be described with reference to a method of recommending movie contents to a user as an example.

The item database 400 may store metadata information such as directors, actors, production years, production costs, tags, and average ratings of a variety of movies, and external data information such as movie introduction material, news and blog of the variety of movies. Also, the usage history database 500 may store usage history information including information such as a viewing time, the number of viewings, and a rating of an individual movie for each user.

The metadata latent vector learning part 210 may learn two types of vectors according to the item database 400 and the usage history database 500 using the Word2Vec algorithm among the artificial neural network algorithms, and the metadata latent vector may be generated by linearly combining the two types of learned vectors as shown in Equation 1.

Vⱼ^{meta}=αVⱼ^{usage}+(1−α)Vⱼ^{data}

In Equation 1, Vⱼ^{meta} may denote a vector of a final metadata value j, Vⱼ^{usage} may denote a vector of the metadata value j learned using the usage history database 500, and Vⱼ^{data} may denote a vector of the metadata value j learned using the item database 400. Also, α may mean a parameter for determining the degree of importance between Vⱼ^{usage} and Vⱼ^{data}, and may be determined through experimentation.

In further detail, the first usage history based training corpus generating part 211 may generate the first training set based on information on movies viewed by respective users according to the usage history database 500. Here, the training data included in the first training set may be generated as one pair formed by grouping a plurality of metadata included in each movie with respect to movies to which a user has given the highest rating. For example, if a user views movies whose directors are A, B, C, and D, respectively, and gives 5 points, 2 points, 5 points, and 5 points to the respective movies when 5 points is the highest rating, (A, C), (A, D), and (C, D) may be included in the first training set as training data.

The item based training corpus generating part 212 may generate the second training set based on the metadata values included in the item information according to the item database 400. Here, there are two methods of generating the second training set.

The first method may be a method of generating training data by grouping two pieces of metadata included in text data into one pair in case of textual information. For example, if the movie directors A and B are mentioned together in text data in which movie or movie related information such as news, blog, and magazine is introduced, the training data may be generated as (A, B).

The second method may be a method of generating training data by grouping two different metadata into one pair when there are different metadata in one item. For example, assuming that tag information is included in the metadata of the movie, if the movie A includes ‘#calm’ and ‘#romantic’ as its tag information, the training data may be generated as (a metadata value indicating ‘#calm’, a metadata value indicating ‘#romantic’).

In other words, the second training set may include training data generated through the first method and the second method described above, and the Vⱼ^{usage} of Equation 1 may be generated by learning the first training set described above through machine learning, and Vⱼ^{data} of Equation 1 may be generated by learning the second training set described above through machine learning.

FIG. 3 is a block diagram illustrating an item latent vector learning part according to an embodiment of the present disclosure.

Referring to FIG. 3, the item latent vector learning part 220 according to an embodiment of the present disclosure may comprise a second usage history based training corpus generating part 221 and a second learning part 225. Here, the components of the item latent vector learning part 220 may be not limited to their names, but may be defined by their corresponding functions to be described later. Also, a plurality of the functions may be performed by one component, and a plurality of the components may perform one function.

The second usage history based training corpus generating part 221 may generate a third training set based on the item usage history of the user stored in the usage history database 500. Here, the third training set may be generated according to a method similar to that in which the first usage history based training corpus generating part 211 generates the first training set.

The second learning part 225 may generate the item latent vector by learning the third training set and the intermediate vectors learned when the metadata latent vector is generated, which are obtained from the metadata latent vector learning part 210.

Here, the intermediate vectors may mean vectors generated from the first training set and the second training set in the process of generating the metadata latent vector, and the intermediate vectors may be used as a feature in generating the item latent vector. Therefore, the item recommendation apparatus 100 according to an embodiment of the present disclosure may use more information than the method using only the usage history, so that the performance can be improved. Even in the case of an item having no usage history, it may be possible to generate an item latent vector by using only metadata values.

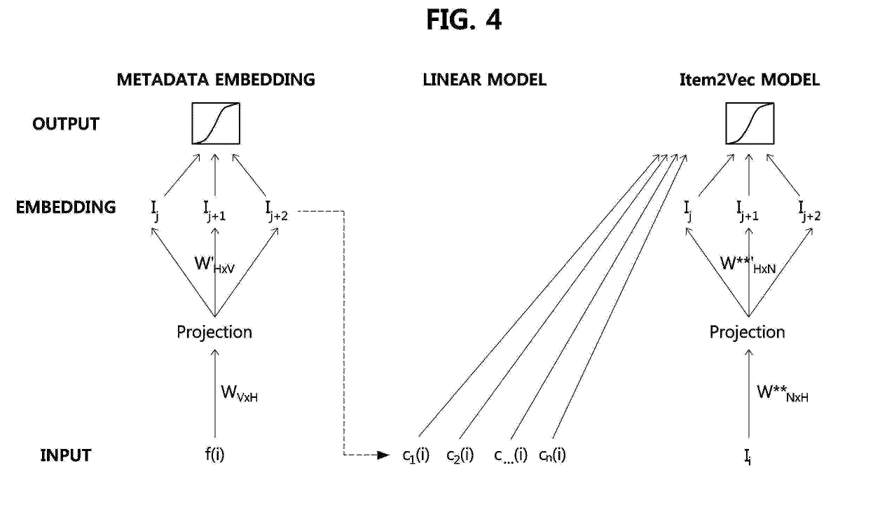

The second learning part 225 may use a specific algorithm modified and enhanced from the Word2Vec algorithm proposed in an embodiment of the present disclosure, but the embodiment of the present disclosure is not limited to thereto. Various types of machine learning or artificial neural network algorithms such as the Word2Vec and the SVM may be used. The specific algorithm proposed in the embodiment of the present disclosure will be described later in detail with reference to FIG. 4.

The detailed operation of the item latent vector learning part 220 according to an embodiment of the present disclosure will be described with reference to a method of recommending movie contents to a user as an example.

The second usage history based training corpus generating part 221 of the item latent vector learning part 220 may generate the third training set in a manner similar to that performed by the first usage history based training corpus generating part 211 of the metadata latent vector learning part 210. Here, the training data included in the third training set may be generated as one pair formed by grouping two movies to which a user has given the highest rating. For example, if the user views movies Alpha, Beta, Gamma, and Delta, respectively, and gives 5 points, 2 points, 5 points, and 5 points to the respective movies when 5 points is the highest rating, (Alpha, Gamma), (Alpha, Delta), and (Gamma, Delta) may be included in the second training set as training data.

The method in which the item latent vector learning part 220 generates the item latent vector by learning the third training set and the intermediate vectors learned when the metadata latent vector is generated, and the specific algorithm according to an embodiment of the present disclosure will be described in detail later with reference to FIG. 4.

FIG. 4 is a conceptual diagram for explaining a method of learning an item latent vector using an intermediate vector according to an embodiment of the present disclosure.

The specific algorithm according to an embodiment of the present disclosure may be an algorithm that modified and improved from the Word2Vec algorithm.

Referring to FIG. 4, metadata embedding is a process of generating the metadata latent vector using the Word2Vec algorithm, which may be performed by the metadata latent vector learning part 210, and an Item2Vec model is a model for generating the item latent vector, which may be performed by the item latent vector learning part 220.

The second learning part 225 of the item latent vector learning part 220 may obtain intermediate vectors Iⱼ, Iⱼ₊₁, and Iⱼ₊₂ located at the middle stage of the metadata embedding process from the metadata latent vector learning part 210, and the obtained intermediate vectors may be used as a feature of the item latent vector. The second learning part 225 may input the third training set generated by the second usage history-based training corpus generating part 221 and the above-described intermediate vectors into a sigmoid module to finally generate the item latent vector. Here, the second learning part 225 may use a back-propagation algorithm.

The back-propagation algorithm may mean a process of updating weights of an artificial neural network as one of the algorithms for learning or training of the artificial neural network. Therefore, the second learning part 225 may perform learning such that a value of Equation 2 reaches the maximum value for positive training data, and the value of Equation 2 becomes the minimum value for negative training data.

$$P ( Y = 1 \vert x ) = σ ( {\sum }_{i} {w}_{linear ( i )} {c}_{i} ( x ) + {w}_{deep}^{T} w 2 v ( x ) ) \qquad [ Equation 2 ]$$

In Equation 2, cᵢ(x) may denote a metadata latent vector of a value assigned to the i-th metadata of an input item x, and wₗᵢₙₑₐᵣ₍ᵢ₎ may denote a weight value for each metadata latent vector. Also, w2v(x) may denote the intermediate vector of the item x learned through the Word2Vec algorithm, and w_{deep}^{T} may denote a weight value for the item latent vector. In other words, the weight values wₗᵢₙₑₐᵣ₍ᵢ₎ and w_{deep}^{T} may be determined to be appropriate values through the back-propagation algorithm.

FIG. 5 is a block diagram illustrating a user latent vector predicting part according to an embodiment of the present disclosure.

Referring to FIG. 5, the user latent vector predicting part 310 according to an embodiment of the present disclosure may comprise a first user latent vector predicting part 311 and a second user latent vector predicting part 312. Here, the components of the user latent vector learning part 310 may be not limited to their names, but may be defined by their corresponding functions to be described later. Also, a plurality of the functions may be performed by one component, and a plurality of the components may perform one function.

The first user latent vector predicting part 311 may predict or generate a first user latent vector based on at least one of the user information obtained by the user interface 600, the usage history database 500, and the item latent vector generated by the item latent vector learning part 220. In other words, the first user latent vector predicting part 311 may obtain information on items used by the user from the user information obtained by the user interface 600 and/or the usage history database 500, and the first user latent vector may be predicted or generated by weighting the corresponding item latent vector based on the number of times which each item is used and usage time of each item.

The second user latent vector predicting part 312 may predict or generate a second user latent vector based on at least one of the user information obtained by the user interface 600, the usage history database 500, and the metadata latent vector generated by the metadata latent vector learning part 210. In other words, the second user latent vector predicting part 312 may obtain information on items used by the user from the user information obtained by the user interface 600 and/or the usage history database 500, and the second user latent vector may be predicted or generated by weighting the corresponding metadata latent vector based on the number of times which each item is used and usage time of each item for each metadata. Here, the user information obtained by the user interface 600 may be stored in the usage history database 500 to update the usage history DB 500.

Although not shown in FIG. 5, the recommendation item generating part 320 may extract at least one recommendation item from the item database based on the item latent vector generated by the item latent vector generating part 220 and one of the first user latent vector and the second user latent vector predicted or generated by the user latent vector predicting part 310, and generate a recommendation list based on the at least one recommendation item. In other words, the recommendation item generating part 320 may calculate a score of a specific item for a specific user by using a value obtained by inner product of the item latent vector and either the first user latent vector or the second user latent vector, and scores of a plurality of items for the specific user may be respectively calculated to generate the recommendation list based on the scores.

The detailed operation of the user latent vector predicting part 310 and the recommendation item generating part 320 according to an embodiment of the present disclosure will be described with reference to a method of recommending movie contents to a user as an example.

The first user latent vector predicting part 311 may obtain information on items used by the user from the usage history database 500 and/or the user interface 600, and set weights of the items. Here, each of the weights may be assumed to be a time for which the user viewed each movie. The item potential vector of the item latent vector learning part 220 may be multiplied by the weight of the item as shown in Equation 3 to generate the first user latent vector.

$${V}_{u}^{user} = {\sum }_{i} watch\_time ( i ) \times {V}_{i}^{item} \qquad [ Equation 3 ]$$

In Equation 3, Vᵤ^{user} may denote the first user latent vector of user u, Vᵢ^{item} may denote the item latent vector of the i-th movie, and watch_time(i) may be the viewing time of the user for the i-th movie.

The second user latent vector predicting part 312 may obtain metadata values of the items used by the user from the usage history database 500 and/or the user interface 600 and set weights of the items. Here, each of the weights may be assumed to be a user's viewing time for each movie including the specific metadata value. The weight values may be multiplied to the metadata latent vector of the metadata latent vector learning part 210 as shown in Equation 4 to generate the second user latent vector.

$${V}_{mu}^{meta} = {\sum }_{j ∈ m} watch\_time ( j ) \times {V}_{j}^{meta} \qquad [ Equation 4 ]$$

In Equation 4, Vₘᵤ^{meta} may denote the second user latent vector for the metadata m of the user u, Vⱼ^{meta} may denote the metadata latent vector of the j-th value among the values that the metadata m may have, and watch_time(j) may denote the viewing time of the user for the movie including the j-th value of the user.

The recommendation item generating part 320 may extract at least one recommendation item from the item database 400 using the item latent vector and one of the first user latent vector and the second user latent vector, and rank the at least one item by calculating scores of the at least one item. More specifically, the recommendation item generating part 320 may calculate a score of the user for each movie using the inner product of the user latent vector and the item latent vector as shown in Equation 5.

\hat{r}ᵤᵢ=μ+bᵤ+bᵢ+Vᵤ^{user}^{^{T}}Vᵢ^{item} [Equation 5]

In Equation 5, \hat{r}ᵤᵢ may denote a predictive score of a movie i for a user u, and μ may be an average score of the entire movies. Also, bᵤ may denote an average score of the user for movies, bᵢ may denote an average score of the movie i, and Vᵤ^{user}^{^{T}}Vᵢ^{item} may denote an inner product of the user latent vector of the user u and the item latent vector of the movie i. In other words, the recommendation item generating part 320 may calculate a score of a specific user for each movie as shown in Equation 5, and recommend a movie having a high score to the user. Also, the recommendation item generating part 320 may calculate a score for metadata as shown in Equation 6, and recommend the user a metadata value having a high score.

\hat{r}ᵤⱼ=Vⱼ^{meta}^{^{T}}Vᵤⱼ^{meta} [Equation 6]

In Equation 6, \hat{r}ᵤᵢ may denote a score for the metadata value, and Vⱼ^{meta}^{^{T}}Vᵤⱼ^{meta} may refer to an inner product of the metadata latent vector for the metadata j and the user latent vector of the user u for the metadata j.

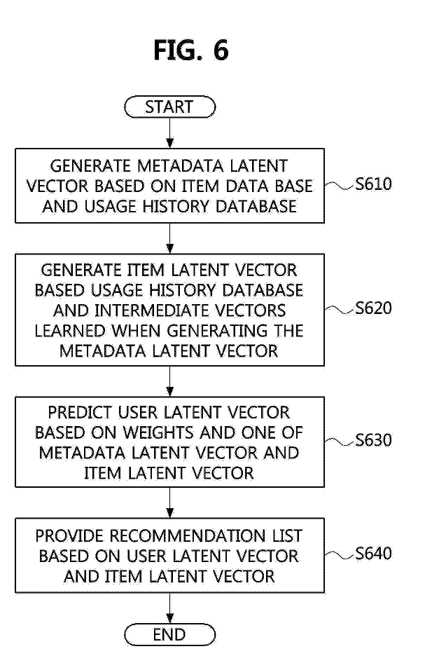

FIG. 6 is a flowchart for explaining a method for recommending items according to an embodiment of the present disclosure.

Referring to FIG. 6, an item recommendation method according to an embodiment of the present disclosure will be briefly described. First, the metadata latent vector may be generated by learning the training set generated based on the item database 400 and the usage history database 500 (S610). The item latent vector may be generated by learning the training set generated based on the usage history database 500 and the intermediate vectors which are learned when generating the metadata latent vector (S620).

Thereafter, weights may be set based on the usage history database 500, and the user latent vector may be predicted using the weights and one of the metadata latent vector and the item latent vector (S630). In the present embodiment, it was described that the user latent vector is predicted using the item latent vector and the weights. However, when there is no or small item usage history information of the user in the usage history database, the metadata latent vector and the weights may be used to predict the user latent vector.

In the item recommendation method, the recommendation list may be generated by extracting at least one recommendation item from the item database 400 based on the user latent vector and the item latent vector, and the recommendation list may be provided to the user (S640). Here, the score for the user may be calculated for each item, and the recommendation list may be generated by ranking the at least one recommendation item based on the scores.

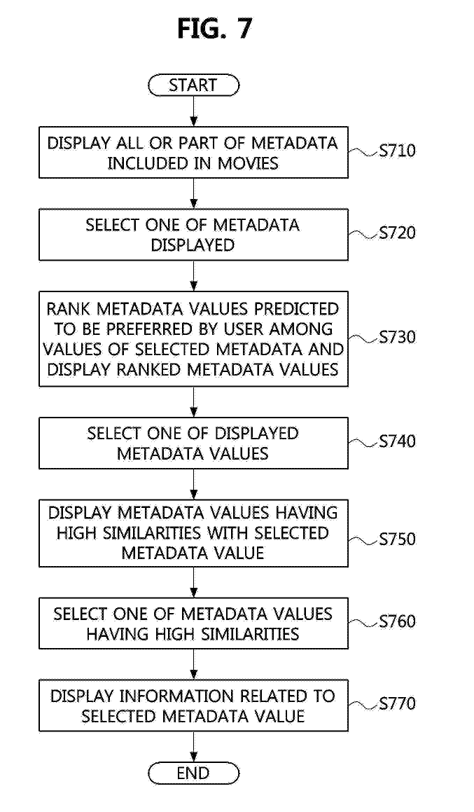

FIG. 7 is a flowchart for explaining a method of recommending metadata based on an item recommendation apparatus according to an embodiment of the present disclosure.

In order to describe the metadata recommendation method according to an embodiment of the present disclosure, it is assumed that a user wants to get recommendation on a director from the item recommendation apparatus of the present disclosure and to view a movie directed by the recommended director.

Referring to FIG. 7, the item recommendation apparatus may display all or a part of metadata for movies such as movie directors, production years, and actors on a connected display device (S710). The movie director metadata may be selected by a user (S720). The item recommendation apparatus may extract movie directors such as movie directors A, B, C, and D, which are predicted to be preferred by the user according to the movie director metadata selected by the user, rank them, and display them on the display device (S730). The user may then select the director B (S740).

Then, the item recommendation apparatus may extract the movie directors E and F having metadata values that are highly similar to the metadata values of the movie director B selected by the user (S750), and display the movie directors E and F on the display device. Here, a metadata value having a high similarity to a specific metadata value may be extracted based a cosine similarity or a Euclidean distance between two metadata values. The user may select the movie director E (S760).

Finally, the item recommendation apparatus may extract a movie directed by the movie director E selected by the user, and recommend the selected movie to the user by displaying the selected movie on the connected display device (S770).

The embodiments of the present disclosure may be implemented as program instructions executable by a variety of computers and recorded on a computer readable medium. The computer readable medium may include a program instruction, a data file, a data structure, or a combination thereof. The program instructions recorded on the computer readable medium may be designed and configured specifically for the present disclosure or can be publicly known and available to those who are skilled in the field of computer software.

Examples of the computer readable medium may include a hardware device such as ROM, RAM, and flash memory, which are specifically configured to store and execute the program instructions. Examples of the program instructions include machine codes made by, for example, a compiler, as well as high-level language codes executable by a computer, using an interpreter. The above exemplary hardware device can be configured to operate as at least one software module in order to perform the embodiments of the present disclosure, and vice versa.

While the embodiments of the present disclosure and their advantages have been described in detail, it should be understood that various changes, substitutions and alterations may be made herein without departing from the scope of the present disclosure.

What is claimed is:

1. A method for recommending an item, the method comprising:
generating a metadata latent vector and an item latent vector based on an item database and a usage history database of items for a specific user,
predicting a user latent vector from user information obtained from the specific user based on the usage history database and one of the metadata latent vector and the item latent vector, and
generating a recommendation list by extracting at least one recommendation item from the item database based on the user latent vector and the item latent vector.

2. The method according to claim 1, wherein the generating of the metadata latent vector and the item latent vector further comprises:
generating the metadata latent vector based on the item database and the item usage history database; and
generating the item latent vector based on the usage history database and at least one intermediate vector learned when the metadata latent vector is generated.

3. The method according to claim 2, wherein the generating of the metadata latent vector further comprises:
generating a first training set based on the usage history database;
generating a second training set based on the item database; and
generating the metadata latent vector by learning the first training set and the second training set through machine learning.

4. The method according to claim 3, wherein the learning of the first training set and the second training comprises learning the first training set and the second training set by using a Word2Vec algorithm.

5. The method according to claim 2, wherein the generating of the item latent vector further comprises:
generating a training set based on the usage history database;
obtaining the at least one intermediate vector, and
generating the item latent vector by learning the training set and the at least one intermediate vector through machine learning.

6. The method according to claim 5, wherein the learning of the training set and the at least one intermediate vector comprises learning the training set and the at least one intermediate vector by using a back-propagation algorithm.

7. The method according to claim 1, wherein the predicting comprises obtaining weights for the specific user based on the usage history database.

8. The method according to claim 7, wherein the predicting further comprises:
predicting a first user latent vector from the user information based on the item latent vector and the weights; and
predicting a second user latent vector from the user information based on the metadata latent vector and the weights.

9. The method according to claim 8, wherein the generating of the recommendation list comprises generating the recommendation list by extracting the at least one recommendation item from the item database based on the item latent vector and one of the first user latent vector and the second user latent vector.

10. The method according to claim 1, wherein the generating of the recommendation list comprises generating the recommendation list by extracting the at least one recommendation item from the item database based on an inner product of the user latent vector and the item latent vector.

11. An apparatus for recommending an item, the apparatus comprising a processor and a memory storing at least one instruction executed by the processor, wherein the at least one instruction is configured to:
generate a metadata latent vector and an item latent vector based on an item database and a usage history database of items for a specific user,
predict a user latent vector from user information obtained from the specific user based on the usage history database and one of the metadata latent vector and the item latent vector, and
generate a recommendation list by extracting at least one recommendation item from the item database based on the user latent vector and the item latent vector.

12. The apparatus according to claim 11, wherein the at least one instruction is further configured to generate the metadata latent vector based on the item database and the item usage history database; and generate the item latent vector based on the usage history database and at least one intermediate vector learned when the metadata latent vector is generated.

13. The apparatus according to claim 12, wherein the at least one instruction is further configured to generate a first training set based on the usage history database; generate a second training set based on the item database; and generate the metadata latent vector by learning the first training set and the second training set through machine learning.

14. The apparatus according to claim 13, wherein the at least one instruction is further configured to learn the first training set and the second training set by using a Word2Vec algorithm.

15. The apparatus according to claim 12, wherein the at least one instruction is further configured to generate a training set based on the usage history database; obtain the at least one intermediate vector, and generate the item latent vector by learning the training set and the at least one intermediate vector through machine learning.

16. The apparatus according to claim 15, wherein the at least one instruction is further configured to learn the training set and the at least one intermediate vector by using a back-propagation algorithm.

17. The apparatus according to claim 11, wherein the at least one instruction is further configured to obtain weights for the specific user based on the usage history database.

18. The apparatus according to claim 17, wherein the at least one instruction is further configured to predict a first user latent vector from the user information based on the item latent vector and the weights; and predict a second user latent vector from the user information based on the metadata latent vector and the weights.

19. The apparatus according to claim 18, wherein the at least one instruction is further configured to generate the recommendation list by extracting the at least one recommendation item from the item database based on the item latent vector and one of the first user latent vector and the second user latent vector.

20. The apparatus according to claim 11, wherein the at least one instruction is further configured to generate the recommendation list by extracting the at least one recommendation item from the item database based on an inner product of the user latent vector and the item latent vector.
